(19) United States
(12) Patent Application Publication
(10) Pub. No.: US 2026/0073344 A1
(43) Pub. Date: Mar. 12, 2026

(54) Address Translation for Non-Standard Locations

(71) Applicant: Todd Waldemar, Portsmouth, VA (US)

(72) Inventor: Todd Waldemar, Portsmouth, VA (US)

(21) Appl. No.: 19/390,198

(22) Filed: Nov. 14, 2025

Related U.S. Application Data
(63) Continuation-in-part of application No. 18/615,968, filed on Mar. 25, 2024, now abandoned.

(51) Int. Cl. G06Q 10/0832; G06V 10/72; G06V 10/74; G06V 10/94; G06V 30/19; G06V 30/414; G06V 40/16; G06V 40/40; G07C 9/25

(52) U.S. Cl. CPC G06Q 10/0832; G06V 10/72; G06V 10/761; G06V 10/95; G06V 30/19193; G06V 30/414; G06V 40/172; G06V 40/45; G07C 9/257

(57) ABSTRACT

The present method and system provides for supplementing a commercial transaction, including providing location data to a commercial transaction system, the location data including location input data and location output data for use by the commercial transaction system. The method and system includes receiving a location identifier from the commercial transaction system, the location identifier indicating a non-postal address identified by a user input into the commercial transaction system based at least on the location input data and the location output data. Therein, the method and system includes presenting the location identifier to a location translation system and receiving a geolocation identifier in response thereto, the geolocation identifier identifying a global positioning location associated with the location identifier. The method and system therein submits submitting the geolocation identifier to the commercial transaction system or in another embodiment to a delivery computing system.

### RELATED APPLICATIONS

The present application is a continuation-in-part of U.S. patent application Ser. No. 18/615,968, filed Mar. 25, 2024, which is hereby incorporated by reference as if fully set forth herein.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF INVENTION

The disclosed technology relates generally to an addressing system and more specifically to a system and method for translating non-standard locations for an addressing system.

### BACKGROUND

Many physical locations have non-traditional addresses, where a non-traditional address is an address not generally recognized by standard addressing systems. By way of example, a military base has barracks or quarters with addressing known to the military base, but not generally recognizable or usable within third-party or commercial addressing systems.

Having a non-traditional address creates numerous problems for delivery and/or other services that rely on standard commercial addressing systems. The residents are unable to partake in various delivery services, including for example food delivery services, grocery delivery services, package delivery services, etc.

When residents do use these commercial systems, the delivery drivers are often confounded, wasting time and typically unable to find the correct building and/or unit.

There are several current solutions, all lacking in specificity to solve this current problem. One solution is adding a GPS location factor to an online order. This is also known as “dropping a pin.” This requires the user to be manually in place to select the location identifier, as well as requiring the delivery person to receive and integrate the GPS location as part of the delivery process. The GPS location does not include driving directions and many GPS location identifiers can be inaccurate to provide improper delivery addresses. Thus, delivery drivers are just as likely to arrive at the wrong location.

Another current solution is generating a designated drop off location and contacting the recipient while approaching delivery drop-off. This requires coordination between the delivery driver and recipient, which if the driver is delayed the recipient can waste time waiting. For general commercial carriers, e.g. UPS, Fed-Ex, DHL, etc., this solution is not a viable option. This solution also fails to allow for delivery to a recipient's door, and thus is not a viable solution for time-sensitive deliveries, for example food or beverages.

As such, there exists a need for a computer processing method and system that supplements commercial transactions by accounting for nonconforming or non-standard address or location information.

### BRIEF DESCRIPTION

The present method and system provides for supplementing a commercial transaction, including providing location data to a commercial transaction system. The location data includes location input data and location output data for use by the commercial transaction system. The method and system includes receiving a location identifier from the commercial transaction system, the location identifier indicating a non-postal address identified by a user input into the commercial transaction system based at least on the location input data and the location output data. Therein, the method and system includes presenting the location identifier to a location translation system and receiving a geolocation identifier in response thereto, the geolocation identifier identifying a global positioning location associated with the location identifier. The method and system therein submits the geolocation identifier to the commercial transaction system or in another embodiment to a delivery computing system.

In one embodiment, the geolocation identifier includes a latitudinal value and a longitudinal value. The geolocation identifier may further include text-based location instructions, for example noting landmarks or other identifiers. The geolocation identifier may further include visual data, for example one or more images of the location or similar visual or graphical data.

The non-postal address may be a physical location not categorized by an address management system. For example, the address management system may be data as managed by the United States Postal Service (USPS).

The non-postal address may be a physical location disposed on a general location or facility that falls outside of the address management system. For example, this can include one or more facilities managed by the United States Department of Defense (DOD), other government entity, a non-government entity, or any other suitable entity or entities. For example, the physical location may be disposed on a military installation or base managed by the DOD. For example, one location may be a barrack used to house military personal. The non-postal address can also identify a particular room within the barrack.

The geolocation identifier is then usable by the commercial transaction system and/or the delivery computing system for facilitating delivery of item(s) acquired as part of the commercial transaction. For example, if a soldier living on in a military barrack orders food from an establishment, the geolocation identifier is usable to supplement the delivery instructions allowing for a delivery driver to find the non-postal address.

### BRIEF DESCRIPTION OF THE DRAWINGS

FIG. 1 illustrates one embodiment of a processing system using the address translation system;

FIG. 2 illustrates one embodiment of a commercial transaction system;

FIG. 3 illustrates one embodiment of the address translation system;

FIGS. 4-6 illustrate sample screenshots of the user input functions as part of the commercial transaction system; and

FIG. 7 illustrates a flowchart of the steps of one embodiment for supplementing a commercial transaction.

FIG. 8 illustrates one embodiment of a system of access authorization of a secured site in accordance with various aspects as described herein.

FIG. 9 illustrates one embodiment of a network node device in accordance with various aspects as described herein.

FIG. 10 illustrates another embodiment of a network node device in accordance with various aspects as described herein.

FIGS. 11A-4B illustrate one embodiment of a method performed by a network node device of access authorization of a secured site in accordance with various aspects as described herein.

FIG. 12 illustrates another embodiment of a network node device in accordance with various aspects as described herein.

A better understanding of the disclosed technology will be obtained from the following detailed description of the preferred embodiments taken in conjunction with the drawings and the attached claims.

### DETAILED DESCRIPTION

The method and system herein provides for non-traditional address translation. The system uses a software interface with one or more databases that connect and translate a specific building name, the building's area name, and room/door number as recognized the occupant. Based on user input, the user submits the non-traditional address, which is translated into a delivery location identifier. In one embodiment, the delivery location identifier can include: (1) geolocation data; and (2) other information.

The address translation system integrates or communicates with a delivery system or portal. The delivery system receives the delivery location identifier and modifies the delivery instructions based thereon. Whereby the user is able to receive a delivery to his or her non-traditional address from delivery networks using standard delivery systems or portals.

The address translation system includes one or more databases that connect a specific building name, the building's area name, and room/door number, as recognized by the occupants, with a verified geolocation of the building. The address translation system can be generated by verifying the actual location of the building and area nomenclature used by the resident, as well as verifying the exact geolocation.

One exemplary embodiment is an on-demand delivery to a barracks on a military base. For example, Camp Lejeune Marine Corps base, Building HP500, Room 250, latitude XXXXXX, longitude YYYYYY. This exact location is verified by the known nomenclature and verified geolocation data. This information is uploaded to an online database. When the occupant at Building HP500, Room 250 places an online delivery order, the occupant can access the address translation system for entering this non-standard address information.

As described in greater detail below, one embodiment may include a user interface, whereby the user selects: (a) the general geographic area (Camp Lejeune); (b) the building (HP500); and (c) additional information such as the room number (Room 250).

The address translation system therefore translates this input into information usable for delivery, for example the geolocation data and any additional identifier information, e.g. building name and room number. This geolocation data and additional information is then integrated into the delivery platform for facilitating delivery.

A second example is an overnight package delivery. The user can access the user interface for submitting the non-traditional address information concurrent with the item ordering. The commercial carrier delivering the package can then supplement delivery instructions with the geolocation data and the additional information.

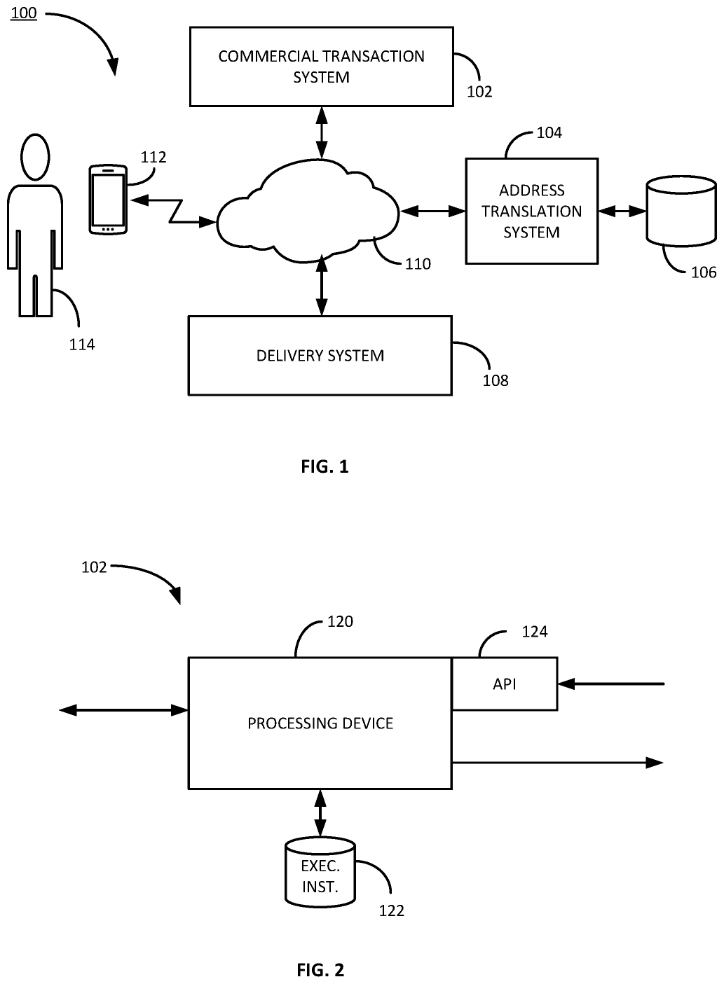

FIG. 1 illustrates one embodiment of a processing system 100 for supplementing a commercial transaction accounting for a consumer or recipient having a non-postal address. The system 100 includes a commercial transaction system 102, an address translation system 104, a geolocation database 106, a delivery system 108. The system includes communication across a network 110 and interacts via a mobile computing device 112 executed by a user 114.

As used herein, a non-postal address may be any address or location not expressly categorized, noted, or maintained within a standardized address management system. In a preferred embodiment, the address management system data is data managed by the United States Postal Service (USPS). This address management system data tracks all recognized postal addresses in areas covered by the USPS. This data serves as the basis for mapping software and navigation software, allowing for generation and distribution of navigational instructions for finding a specific location.

In one embodiment, the non-postal address may be a physical location disposed on a location managed by the United States Department of Defense (DOD). For example, the physical location may be disposed on a military installation or base managed by the DOD. For example, one location may be a barrack used to house military personal. It is recognized that where a DOD location itself can be recognized and cataloged within the standard address management system, locations within the DOD location are not and thus addresses within DOD locations are non-postal addresses.

The commercial transaction system 102 may be any suitable software processing system for facilitating a commercial transaction, having additional processing capabilities as noted herein.

For example, one embodiment of a commercial transaction system can be a food or grocery ordering software system. The commercial transaction system can include menus or other datasets of items available for purchase and allow the user to engage in standard commercial transactions of selecting item(s) for purchase. The commercial transaction system 102 includes additional processing elements facilitating the supplementation as noted herein. The above examples of food or groceries are general examples and are not expressly limiting in nature, where the commercial transaction system 102 can provide for any suitable type of commercial transaction.

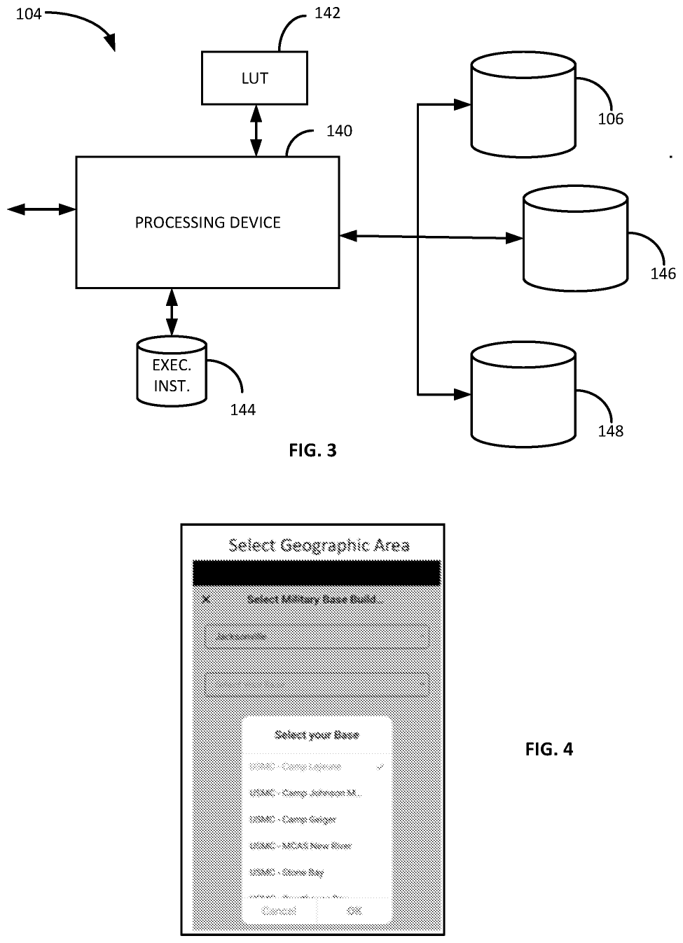

FIG. 2 illustrates one exemplary embodiment of the commercial transaction system 102. This system 102 includes a processing device 120 and executable instructions 122. Additionally, the system 102 includes an address translation module 124, for example one embodiment being an application program interface (API). The API 124 facilitates additional functionality for the processing device 102, in addition to the executable instructions 122.

In reference back to FIG. 1, the commercial transaction system 102 can communicate with the address translation system 104 via the network 110. The network 110 can be any suitable network or combination of networks, including for example but not limited to the Internet, an intranet, etc. As recognized by a skilled artisan, communication between system 102 and 104 may include communication protocols, encryption, and other network administrative elements.

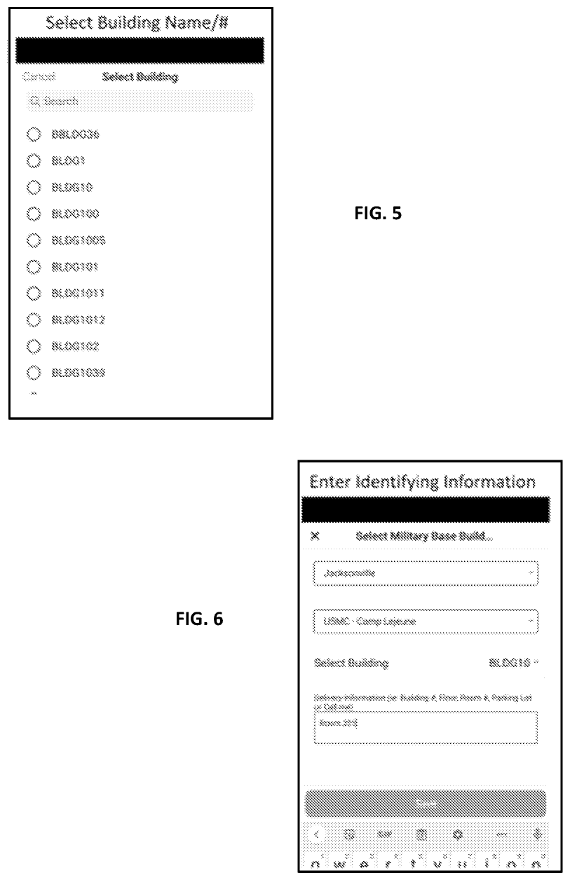

FIG. 3 illustrates one embodiment of the address translation system 104. This embodiment may be disposed in a network processing environment, for example in a cloud-based application system. In one embodiment, system 104 may be disposed within or integrated within a commercial transaction system (102 of FIG. 1) and is not expressly required to be a separate processing system. In one embodiment, system 104 may be disposed within the delivery system 108 of FIG. 1.

The address translation system 104 includes one or more processing devices 140 and may include in one embodiment a look-up table 142. The system 104 includes at least non-transitory memory device having executable instructions stored therein, the processing device performing processing operations in accordance with the executable instructions. The look up table 142 may be a reference dataset relating to interfacing with the commercial transaction system as described in greater detail below.

In further embodiments, the device 140 accesses any number of databases 106, 146, and 148. The databases can include varying forms of geolocation identifier information. For example, dataset 106 may include global positioning information. For example, dataset 146 may include text-based location instructions or other text information associated with a location. For example, dataset 148 may include images of one or more locations.

In FIG. 1, the delivery system 108 may be any suitable software application providing delivery of ordered item(s).

In one embodiment, the delivery system 108 may be part of the commercial transaction system 102 where the system 102 provides for delivery as part of the service. For example, a food company that makes pizzas may include drivers that deliver pizzas, therefore where the users order pizzas in the commercial transaction system, the same pizza company may also provide the delivery system 108.

In one embodiment, the delivery system 108 may be a third party service provider that compliments the commercial transaction system 102. For example, a first vendor may sell groceries and other items, but a second vendor delivers the orders. In this embodiment, the system 102 and 108 may be separate processing systems.

In one embodiment, the delivery system 108 may be the user interface or portal application facilitating the commercial transaction and providing the commercial transaction system 102. For example, a delivery vendor may have numerous drivers available to deliver items, but also provides a software application allowing users to select from a number of possible restaurants (or other vendors), order food (or other items) via the delivery vendor application. In this embodiment, the system 102 and 108 can both be within the same processing system.

The processing device 112 may be any suitable computing device capable of interacting with applications or other software. For example, the device 112 may be a mobile phone running an “app” allowing the user 114 to place an order for delivery. For example, the device 112 may be a laptop or desktop computer for the user 114 to run a browser application and order via a web location.

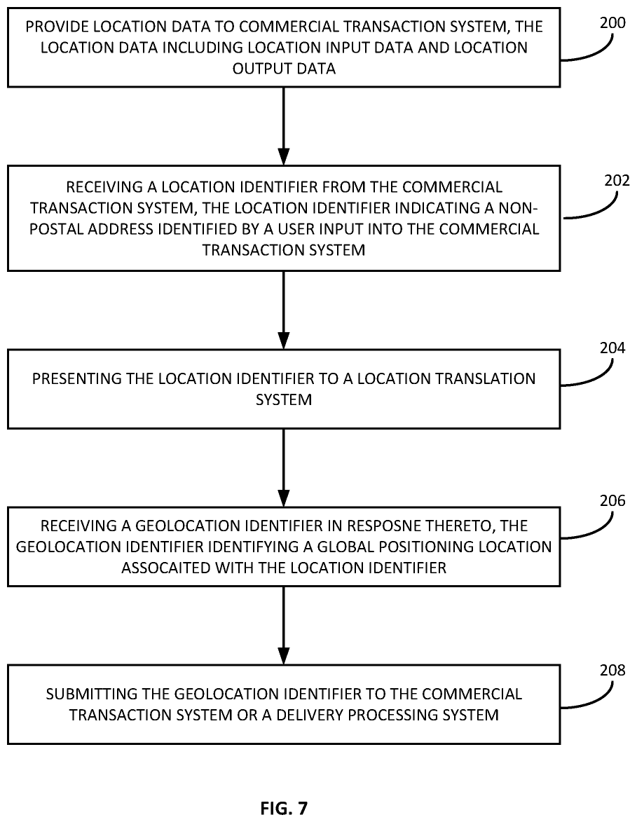

FIGS. 4-6 illustrate sample screenshots of user interfacing operations associated with supplementing a commercial transaction. These screenshots represent sample interface options available for a user while executing the commercial transaction. For example, the user can launch an app to order food from a local restaurant, the app including a button to select if the user seeks delivery to a non-postal address.

If selected, FIG. 4 illustrates a first pull-down menu screen for the user to select a geographic area, and then listing military bases. Here, the user can select his or her military base.

Populated data fields within the app can include sub-levels of information for buildings within the various military bases. FIG. 5 illustrates a sample next screen from the user in FIG. 4 selecting Camp Lejuene. In FIG. 5 the user is presented with available buildings. The user can select a corresponding radio button for the building number.

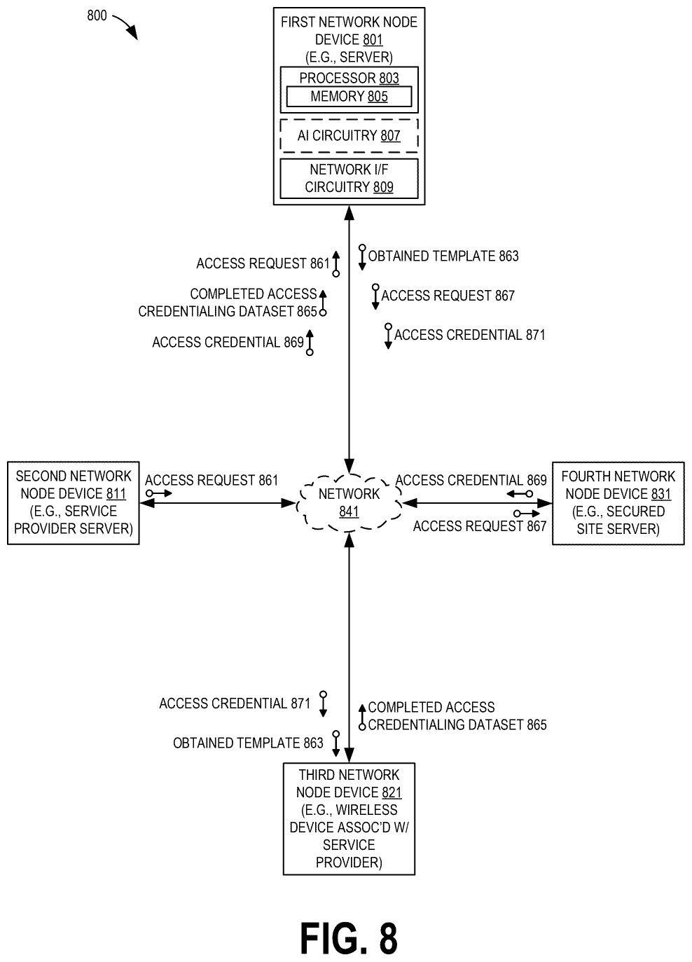

FIG. 6 illustrates a sample screenshot following FIG. 5, where the user selected BLDG10. In this embodiment, the user is presented with an additional question of a room number. Here, the user can be presented with additional pull-down menus or this exemplary embodiment allows the user to type in a particular room number.

Where FIGS. 1-3 illustrate processing system embodiments and FIGS. 4-6 illustrate sample screenshots, FIG. 7 illustrates a flowchart of the steps of one embodiment of a method for supplementing a commercial transaction. Step 200 is providing location data to a commercial transaction system, the location data includes location input data and location output data for use by the commercial transaction system.

For example, in FIG. 1, the system 104 may provide this data to the system 102. The location data includes data usable by the processing device 120 via the API 124 (FIG. 2). This location data includes input data in the form of data usable by the processing device 120 (FIG. 2) for supplementing the user interface. For example, as noted in FIGS. 4-5 screenshots, the input data can include the listing of bases, or other locations having non-postal addresses, and buildings located thereon. Where the input data is data usable by the commercial transaction system 102 within the user interfacing, the output data is data capable of being sent back to the address translation system 104. In some embodiments, the output data may be the same as the input data, e.g. a listing of locations and buildings.

In other embodiments, the output data may be one or more data fields or identifiers associated with a particular location but usable by the address translation system for later processing. For example, if the input data is a listing of military bases and buildings on the base, the output data may be data strings representing a selected base and building. The output data may also include a data field or fields for manually entered information, for example the user manually typing in a room number.

Step 202 is receiving a location identifier from commercial transaction system. The location identifier indicates a non-postal address identified by a user input into the commercial transaction system. In one embodiment, the location identifier may include the location output data or a variation of or reference to the location output data.

In between steps 200 and 202, the user engages the commercial transaction system for conducting a commercial transaction. For example, the user may order food, groceries, or any other item and the commercial transaction includes user interface software allowing the user to indicate the non-postal address, e.g. FIGS. 4-6.

The commercial transaction system conducts processing operations for the commercial transaction, and uses the address translation system for the non-postal address. In the address translation system, step 204 is presenting the location identifier to a location translation system. The location translation system may be a processing module within the processing device 140 of FIG. 3, providing for data lookup and/or data translation operations.

In one embodiment, the location translation system can use the location identifier as a search or data retrieval function from a database, such as database 106 of FIG. 3. For example, if the location identifier is a data field indicating a location (military base); name of building (barrack); room number, this data field can be used as a data search input string.

In another example, the location output data of step 200 may include data for generating a data string, such as a hash value or other string. For example, location names may be assigned a first set of values and buildings may be assigned a second set of values, the data string being a combination of the values. Therein the location identifier can be the data string, the processing device may access a lookup table to correspond the data string with a search value. The search value is usable for searching and retrieving geolocation information.

Step 206 is receiving a geolocation identifier in response to the search request. The geolocation identifier identifies a global position location associated with the location identifier. For example, one embodiment of global position location may be longitudinal and latitudinal values.

In further embodiments, the geolocation identifier may include additional or complimentary data. For example, data may include written instructions or other information associated with finding the location such as notation of landmarks, designation of one-way streets or travel restrictions, etc. Other information may include images, such as photographs of the building, driveways, designated parking locations, etc.

Step 208 is submitting the geolocation identifier to the commercial transaction system or a delivery processing system. For example, the geolocation identifier can be transmitted to the commercial transaction system, where the geolocation identifier replaces the standard postal address information. For example, a delivery platform may receive the geolocation identifier to compliment delivery instructions or other information from the commercial transaction system.

In further embodiments, the geolocation identifier may include additional data fields for text or other user-submitted information. In the FIG. 6 screenshot, the user manually enters a room number. This data entry can be captured and added as the data field. In another embodiment, original content recognition (OCR) or other data processing operations may be utilized to recognize and translate the user data entry. For example, OCR software may process the FIG. 6 enter of “room 301” and insert “301” or “room 301” as part of the geolocation identifier or as part of complimentary data associated with the geolocation identifier.

Therein, the methodology of FIG. 7 provides for complimenting the commercial transaction by allowing transactions and delivery of non-postal addresses.

Further embodiments can provide for additional techniques for collecting information associated with the geolocation identifier. These examples can include user-generated content by one or more users manually inserting information into the databases 106, 146, 148 of FIG. 3. For example, someone may manually walk around and collect and record GPS coordinates. For example, someone may take pictures of buildings, landmarks, and other features for supplementing the GPS information. For example, someone may be manually enter text or other instructions for complimenting delivery or finding a location, e.g. designating a parking location, noting nearby traffic concerns such as restricted areas and one-way streets, etc.

For example, using the example noted above, the identifying information can be Building HP500 and Room 250. The identifying information can also include notes that the building is between buildings HP300 and HP700 and there is a specific landmark across the street.

The identifying information may be user-generated. The identifying information could also be generated by delivery drivers, supplementing the information with content germane to his or her delivery experiences.

In one embodiment, the database content usable by the address translator is generated by physical inspection and data entry associated with the non-traditional addresses. In this embodiment, one or more content creators can physically walk around the location, tracking geolocation information associated with specific buildings and rooms.

Creating this content can include a geolocation acquisition function with associated identifying information fields. For example, while operating on a mobile device, an application can record the geolocation data and use data input fields for receipt of the identifying information. Information could also include photographs.

The present method and system may utilize any number of available techniques for building or maintaining the one or more databases with verified geolocation. For example, one embodiment may include accessing pre-existing mapping data, such as available from the Department of Defense for military bases or other pre-existing data sets. In another example, data can be collected using drones or other mobile devices with a GPS location identifier and/or cameras.

The database content may be supplemented with iterative usage by various users. The database content can also be supplemented by feedback from one or more delivery drivers.

In further embodiments, geolocation data can be secured or encrypted data. For example, where security concerns arise, geolocation information may be restricted to secure communication devices or limited distribution across delivery or commercial transaction platforms.

Therefore, the present method and system overcomes delivery limitations associated with non-postal addresses. The method and system, integrated within commercial transaction software, supplements commercial transactions and/or delivery instructions by generating the geolocation information for non-postal addresses.

FIGS. 1 through 7 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein.

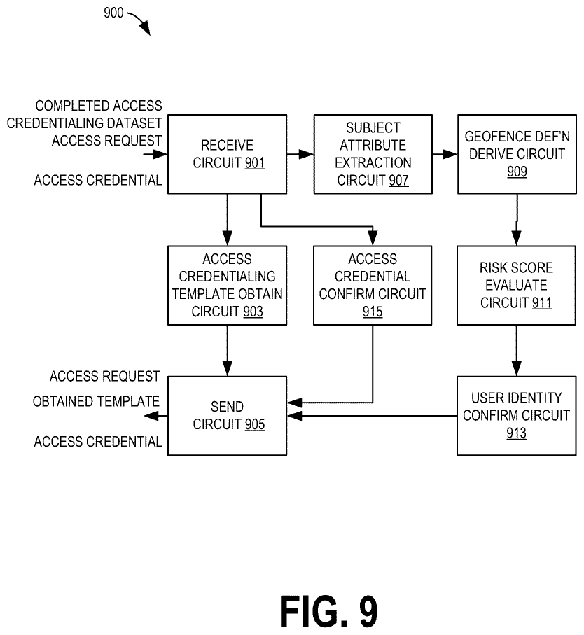

FIG. 8 illustrates one embodiment of a system 800 of access authorization of a secured site in accordance with various aspects as described herein. In FIG. 8, the system 800 communicatively couples four devices 801, 811, 821, 831 over a network 841 (e.g., Internet) to coordinate controlled entry into a secured site. A secured site can include any physical facility, campus, building, grounds, or designated geographic zone in which access by the general public is restricted, regulated, or conditioned on one or more access controls (e.g., credential presentation, identity verification, screening, escort, appointment, physical barriers, guards, or automated access-control devices). Examples include an army base; other military installations; airports and seaports (including sterile/secured areas); border crossings and ports of entry; government or corporate campuses; data centers; hospitals and laboratories; warehouses and distribution centers; stadiums and arenas; schools; rail yards; energy and utility facilities (power plants, substations, refineries); construction sites; gated communities; and temporary or event-based perimeters established by geofencing or physical barriers. A secured site may be permanent or temporary, indoor or outdoor, public-facing at its outer boundary but internally segmented into controlled sub-zones, and may be one of a plurality of secured sites managed under common or federated access policies.

In FIG. 8, a first network node device 801 (e.g., a server) can include processing circuitry 803 operatively coupled to memory 805, AI circuitry 807 that runs machine-learning models, and network interface circuitry 809 that handles secure communication. The first network node device 801 can exchange messages with a second network node device 811 (e.g., service provider server), a third network node device 821 (e.g., wireless handset used on the provider's fulfillment side), and a fourth network node device 831 (e.g., a server that controls access for the secured site). A service provider can include any organization or platform that coordinates on-demand or scheduled pickup, transport, or delivery of people or things using fulfillment-side personnel or contractors and customer-side requesters. The service can operate one or more backend computing systems (e.g., second network node device 811) that create, dispatch, or track jobs; manage user accounts or roles; or exchange access-related messages with the first network node device 801 to support entry into secured sites. Examples include ride-hailing and mobility platforms (e.g., Uber, Lyft), meal delivery (DoorDash, Uber Eats, Grubhub), grocery delivery (Instacart, Shipt, Amazon Fresh/Whole Foods, Walmart Grocery), courier and same-day services (Postmates, Gopuff, Roadie, FedEx SameDay, UPS on-demand, DHL Express), retail pickup/BOPIS and curbside programs (Target, Best Buy, pharmacy chains), specialized logistics (medical couriers handling specimens or medications, secure document couriers, tool/equipment runners), and facility or event services coordinated via workforce platforms (e.g., Brink's, GardaWorld, Allied Universal, TaskRabbit). In these systems, a fulfillment-side user account (e.g., driver, courier, runner, technician) can be distinct from a customer-side user account used to place orders or request rides; the service provider's backend may submit access requests with site identifiers, delivery windows, and coordinates, supply account metadata or device-attestation signals, receive validation errors for correction, and receive or relay machine-verifiable access credentials for presentation at a secured site. The third network node device 821 can be signed in with a fulfillment-side user account (a role used for pickup/transport/drop-off, distinct from a customer account that places orders). A deliverable entity can include what is being delivered or escorted—this may be a person, a parcel, groceries, a meal order, or equipment. A delivery location inside the secured site can be identified by geographic coordinates (e.g., latitude/longitude, WGS-84 with fixed precision).

In operation, the process can begin when the first device 801 receives a first indication 861 from the second device 811 requesting access to a particular secured site such as to deliver the deliverable entity to the coordinate-identified location. To prepare the required credentialing, the first device 801 can consult a template repository that stores site-specific access-credentialing dataset templates for many different secured sites. A template can include a form definition-user-interface elements and field rules—for the information a site requires (e.g., name, phone, email, government-ID number, license plate, insurance proof, visit purpose). The first device 801 can select the template for the target site and may also determine which other secured sites are near the courier's current location, select those nearby templates, and merge their fields to create a single “obtained template” that covers variations among proximate sites. The first device 801 can then send a second indication 863 to the third device 821 with the obtained template and instructions that cause the courier handset to present the form and collect the required information.

Once the form is completed, the third device 821 can return a third indication 865 to the first device 801 with a completed access-credentialing dataset. This dataset can include a self-image (e.g., a live capture or “selfie” taken during credentialing, a short burst of frames for liveness detection) and an identification document image (e.g., a driver's license, passport). Using the AI circuitry 807, the first device 801 can execute optical character recognition on the ID image to extract machine-readable subject attribute values (e.g., name, number, issuing state, and date of birth). The first device 801 can then normalize those values to canonical formats so they are unambiguous and easy to validate (e.g., dates as ISO-8601 (YYYY-MM-DD), phone numbers as E.164, coordinates as fixed-precision WGS-84, and identification numbers as jurisdiction-prefixed, zero-padded strings). The AI circuitry 807 can also compute a facial similarity score by comparing the self-image to the headshot on the identification-document image and, in some embodiments, performs liveness detection on the self-image to produce a liveness score that helps detect spoofing.

With the delivery coordinates, the first device 801 can derive a geofence definition that bounds where the credential will be valid such as a policy-selected circular radius around the drop-off point, a polygon defining a zone within the site, or the like. The first device 801 can evaluate a risk score that fuses the normalized attributes, the facial-similarity result, or the geofence, and may also incorporate context such as the fulfillment account's history, time of day, the handset's 821 device attestation state, or the distance from the site perimeter. When the risk score and any liveness/face-match thresholds are satisfied, the first device 801 can confirm the courier's identity. After confirming identity, the first device 801 can send a fourth indication 867 to the fourth device 831 (e.g., secured site's access server) requesting access. This request can include the geofence and a requested time window so the site can issue a credential with those constraints. To reduce what is shared, the first device 801 may redact the dataset to a minimum information payload by tokenizing selected attributes (e.g., replacing an ID number with a hash) and sending only the minimum needed. The fourth device 831 can return a fifth indication 869 with a machine-verifiable access credential. A machine-verifiable access credential can include a digitally signed, presentation-ready token that a gate or other access-control device can validate by checking the token's signature against a locally stored trust anchor (e.g., a pinned public key or root certificate). The credential can authorize entry for a specific purpose and can embed constraints such as who is authorized, which site or zone (including a geofence), and when (a short validity window). Because the credential can be signed and structured, the receiving device can verify authenticity and integrity, parse the claims, or enforce policy in real time. The credential can include a JSON Web Token (JWT) signed with JWS or a CBOR Web Token (CWT) signed with COSE or can be rendered as a QR code for optical scanning or carried in an NFC payload for tap-to-enter. The token's claims can include an issuer (e.g., site authority), an audience (e.g., gate device), a site identifier, latitude/longitude plus a radius or polygon for the geofence, a not-before/expiration time window, a transaction ID, or a confirmation claim that binds the token to a hardware-backed public key on the presenter's device (so only that device can use it). Other realizations can include a short-lived X.509 certificate with site-specific extensions, or a W3C Verifiable Credential signed by the site authority but delivered as QR or NFC. Verification at the gate can follow a simple flow: parse the credential; verify the signature with the trust anchor; check issuance and expiry (and any revocation); confirm the intended audience/site; ensure the presenter is within the geofence and inside the time window; and, if the credential is device-bound, challenge the device to sign a nonce as proof of possession. If all checks pass, the access control device can grant entry. If any check fails, access can be denied. The first device 801 can verify the credential's digital signature using a trust anchor associated with the secured site (e.g., a pinned public key or root certificate) and reject the credential if verification fails.

In FIG. 8, the first device 801 can then deliver the credential to the courier handset via a sixth indication 871. In some cases, the first device 801 can also produce a device-bound version of the credential by binding it to a hardware-backed public key on the handset 821 so a stolen screenshot cannot be replayed from another device. Finally, the first device 801 can cause the third device 821 to present the credential at the secured site's access control device (e.g., a gate kiosk, guard tablet, or turnstile scanner) to obtain entry and complete the delivery within the geofence and time window. If the completed form was malformed or missing required data, the first device 801 can validate the dataset against a schema (field requirements and canonical formats) and, upon finding a problem, can send a seventh indication back to the handset 821 identifying the specific field-level error so it can be corrected.

The AI circuitry 807 can accelerate the OCR, facial-similarity, and liveness models, while the processing circuitry 803 can handle orchestration, policy evaluation, cryptography, and auditing. The memory 805 can store program code, the templates and schemas, policy thresholds, trust anchors, risk model parameters, and audit records correlating the indications 861-871 with timestamps and IDs. The network interface circuitry 809 can provide secure connectivity (e.g., TLS-protected APIs) among the four devices 801, 811, 821, 831 over network 841. Other features can include issuing revocation messages if misuse is detected (e.g., presentation outside the geofence or from the wrong device), rotating trust anchors, and enforcing retention policies that delete selected subject attributes after a set period while retaining tokenized values and audit trails.

In another exemplary embodiment, the secured site access workflow can be deployed in a base-operated mode in which the fourth network node device 831 (e.g., secured site server) can execute the access control platform and can directly issue machine verifiable access credentials, while the first network node device 801 can operate as an access broker that standardizes templates, normalizes attributes, computes risk, and exchanges signed requests and responses over mutually authenticated APIs.

In another exemplary embodiment, the workflow can be deployed in a broker-operated mode in which the first network node device 801 can supply credentialing services, geofence/time-window construction, and device-bound tokens, and interoperates with a Department-of-the-[military/Defense] access authority via a federation interface. In this mode, some features (e.g., onsite credential issuance or gate policy) may be exercised only where the base has opted-in or has a governing contract; otherwise the system performs a subset (template capture, normalization, risk scoring, and referral) while the base's native system completes issuance.

In another exemplary embodiment, the system can be role agnostic and can apply to any non-CAC visitor class, including delivery personnel, vendors, contractors, subcontractors, temporary staff, guests, and family visitors. The third network node device 821 can thus represent any requester's handset registered to a fulfillment-side or visitor account, not limited to a delivery driver.

In another exemplary embodiment, the system can implement a sponsor approval process introducing a third stakeholder (e.g., sponsor) in addition to the secured site authority and the requester. The first device 801 can generate a sponsor approval artifact (e.g., signed deep link, approval code) addressed to a designated sponsor (unit, commissary/exchange, contracting office, individual service member). The sponsor can authenticate, can review request details (e.g., identity, purpose, time window, geofence), and can issue an approval or denial that is cryptographically bound to the access request and logged for audit.

In another exemplary embodiment, the sponsor approval artifact can be multi-party and can support chained or parallel approvals (e.g., unit commander, facilities office), each adding a signature and policy constraints (e.g., time reduction, alternate gate, escort requirement) before the fourth device 831 issues the credential.

In another exemplary embodiment, the first device 801 can enforce micro-security by isolating delivery/visit operations to a lat/long-defined micro-geofence and a short validity time window (e.g., minutes or hours). The credential can encode a primary delivery location, optional route corridors between a designated gate and the location, dwell-time limits, and no-go sub-zones. Attempted presentation or device location outside these constraints can result in real-time policy actions (e.g., warning, escalation, revocation).

In another exemplary embodiment, the system can provides an AI-powered security dashboard that fuses telemetry (e.g., credential claims, device attestation, liveness/face scores, geofence compliance, route adherence, dwell times) to surface anomalies, predict risk, and recommend interventions. The dashboard can highlight out-of-pattern travel, stale devices (e.g., no heartbeat), repeated near-miss geofence exits, and clustered events across multiple visitors to indicate potential coordinated threats.

In another exemplary embodiment, the system can require the requester's handset 821 to maintain active telemetry for the pass to remain valid, including periodic location proofs, device attestation proofs (e.g., key still hardware-backed, no debugger/root), and heartbeats within a defined interval. Failure to satisfy telemetry policies can downgrade or suspend the credential and notifies base security via the dashboard.

In another exemplary embodiment, the system can integrate with a tokenization service (e.g., tokenization broker) that converts human-readable building identifiers, unit names, or on-base addresses into canonical geospatial targets (e.g., lat/long with precision) and can return ephemeral tokens that the service provider can embed in orders. The first device 801 can redeem the token to retrieve the coordinates and policy bundle without exposing sensitive site addressing schemes.

In another exemplary embodiment, the system can define a first scenario (e.g., on-base food/grocery delivery) in which a service member orders from a marketplace (second device). The order can include a tokenized destination that resolves to lat/long and a narrow delivery window. The first device 801 can perform credentialing, sponsor approval (e.g., unit/commissary), risk evaluation, and can issue a time- and geofence-constrained credential delivered to the courier handset. The marketplace can integrate through a broker API that also supports status callbacks and revocation notices.

In another exemplary embodiment, the system can define a second scenario (e.g., visitor invitation) in which a service member (acting as sponsor) initiates an invite through a portal. The first device 801 can send the third device 821 (visitor handset) a secure link to complete the access credentialing dataset; upon sponsor approval and risk acceptance, the pass can be issued for a short visit window and may require escort or restricted corridor travel to a meeting point.

In another exemplary embodiment, the system can defines a third scenario (e.g., contractor fleet access) in which a company uploads a roster via a dashboard. The first device 801 can perform batched template capture, ID verification, liveness, and risk evaluation; can route the batch for sponsor approval (e.g., commissary/exchange/contracting office); and can coordinate issuance of longer-term credentials (e.g., monthly/annual) that nonetheless enforce daily time windows, zone limitations, periodic liveness renewal, and device-binding to assigned handsets/vehicles.

In another exemplary embodiment, the credential can encode a designated gate list and ingress route; gate devices can verify the audience claim against their site/gate identity and can reject credentials not enumerating that gate. Route compliance can be assessed continuously; deviation beyond a configured tolerance can triggers graduated responses (e.g., message to handset, dashboard alert, credential suspension).

In another exemplary embodiment, the system can support emergency posture changes (e.g., FPCON). The fourth device 831 (or an authorized controller) can broadcast a posture update that tightens thresholds (e.g., reduces validity windows, shrinks geofences), pauses issuance, or mass-revokes active passes. The first device 801 can disseminate the new posture to requesters and sponsors and can update the risk models accordingly.

In another exemplary embodiment, the access credential can embed communication channels (e.g., a signed callback endpoint or push token) enabling base security to issue real-time instructions to the handset (e.g., hold position, proceed to checkpoint, exit route). The handset UI can acknowledge receipt, and compliance events can be cryptographically attested and logged.

In another exemplary embodiment, the system can support tiered privacy: for visitor classes with heightened privacy requirements, the first device 801 can transmit only minimum information payloads to the site (e.g., tokenized IDs, pseudonymous identifiers) while still enabling onsite verification using the trust anchor and proof-of-possession challenges. Rich subject attributes can remain encrypted at the broker and can be deleted per retention policies.

In another exemplary embodiment, the system can include interoperability adapters to legacy base systems (e.g., visitor management, NCIC/LE checks, vendor rosters). The first device 801 can package normalized attributes and liveness/facial scores into a standards-based envelope (e.g., signed JSON/COSE object) consumable by legacy APIs and can reconcile decisions and revocations bi-directionally.

In another exemplary embodiment, the system can support graduated sponsorship for multi-day events (e.g., air shows, exercises). Sponsors can approve a cohort once; the first device 801 can schedule per-day micro-passes with shorter windows and event-zone geofences. Each morning, the cohort handsets can receive fresh, device-bound credentials after a brief liveness check.

In another exemplary embodiment, for non-pedestrian deliveries, the credential can bind vehicle identity (e.g., plate, VIN, telematics ID) and the handset/device public key. Gate devices can verify both optical/NFC payloads and, where available, license-plate recognition. Route corridors can include vehicle width constraints (e.g., no entry to pedestrian only sub-zones).

In another exemplary embodiment, the first device 801 can provide monetizable integration points for service providers via the broker API (e.g., template pre-fill, token redemption, credential status webhooks, revocation feed), enabling providers to embed secured site access requests directly into their order flows and to receive real-time guidance (e.g., approved/denied, gate assignment, ETA compliance).

In another exemplary embodiment, the system can support offline-first gates.

Credentials can carry short validity and freshness proofs (e.g., signed timestamps, rolling nonces) so that gate devices can validate without network connectivity and still detect replay and expired tokens. When connectivity resumes, gate logs can reconcile with the first device 801 for full auditability.

In another exemplary embodiment, the system can implement continuous authorization: while the visitor is on site, the handset 821 can periodically re-prove presence within the micro-geofence and respond to liveness prompts. Failure can trigger staged response (e.g., temporary restriction, escort request, or revocation), and the credential can be re-issued with a shortened window to complete the task or exit.

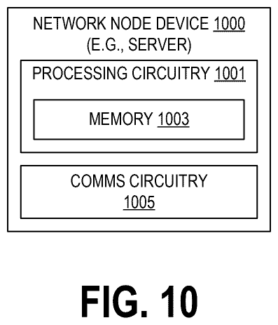

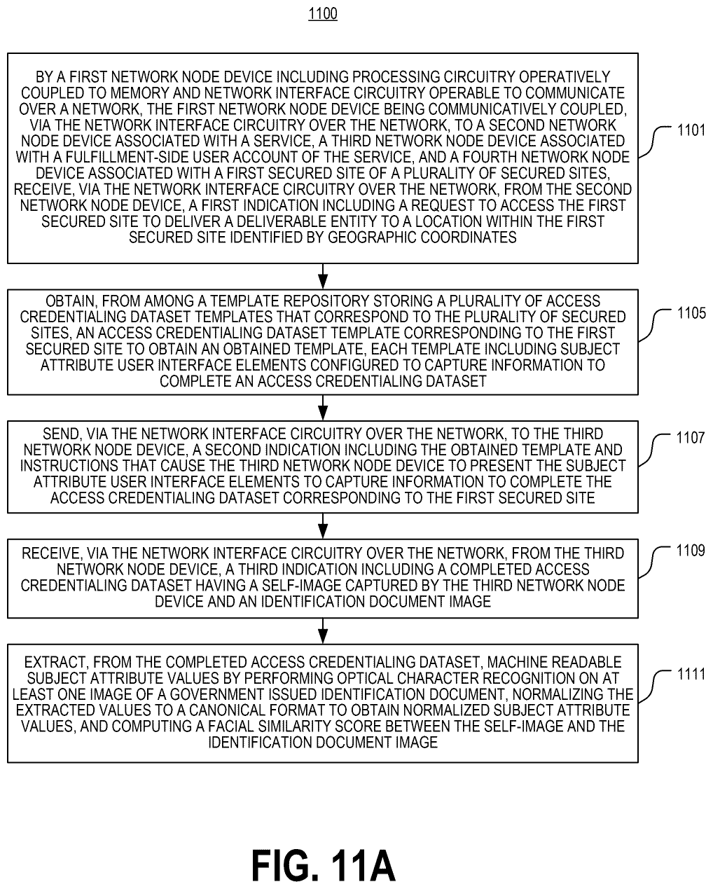

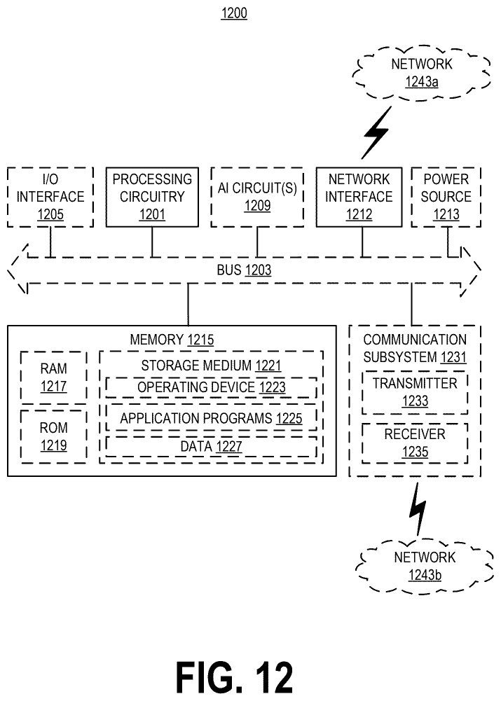

FIG. 9 illustrates one embodiment of a network node device 900 in accordance with various aspects as described herein. In FIG. 9, the device 900 implements various functional means, units, or modules (e.g., via the processing circuitry 1001 in FIG. 10, via the processing circuitry 1201 in FIG. 12, via software code, or the like), or circuits. In one embodiment, these functional means, units, modules, or circuits (e.g., for implementing the method(s) described herein) may include for instance: a receive circuit 901 operable to receive information; an access credentialing template obtain circuit 903 operable to obtain, from among a template repository storing a plurality of access credentialing dataset templates that correspond to the plurality of secured sites, an access credentialing dataset template corresponding to the first secured site to obtain an obtained template, each template including subject attribute user interface elements configured to capture information to complete an access credentialing dataset; a send circuit 905 operable to send information; a subject attribute extraction circuit 907 operable to extract, from the completed access credentialing dataset, machine readable subject attribute values by performing optical character recognition on at least one image of a government issued identification document, normalizing the extracted values to a canonical format to obtain normalized subject attribute values, and computing a facial similarity score between the self-image and the identification document image; a geofence definition derive circuit 909 operable to derive, from the geographic coordinates, a geofence definition including at least one of a polygon and a radius that bounds the location within the first secured site; a risk score evaluate circuit 911 operable to evaluate a risk score based at least in part on the normalized subject attribute values, the facial similarity score, and the geofence definition; a user identity confirm circuit 913 operable to confirm a user identity associated with the third network node device based at least in part on the risk score; an access credential confirm circuit 915 operable to confirm the access credential; or the like.

FIG. 10 illustrates another embodiment of a network node device 1000 in accordance with various aspects as described herein. As shown, the device 1000 includes processing circuitry 1001 and communication circuitry 1005 (e.g., network interface circuitry). The communication circuitry 1005 is configured to transmit or receive information to or from one or more other nodes (e.g., via any communication technology). The processing circuitry 1001 is configured to perform processing described above, such as by executing instructions stored in memory 1003. The processing circuitry 1001 in this regard may implement certain functional means, units, or modules.

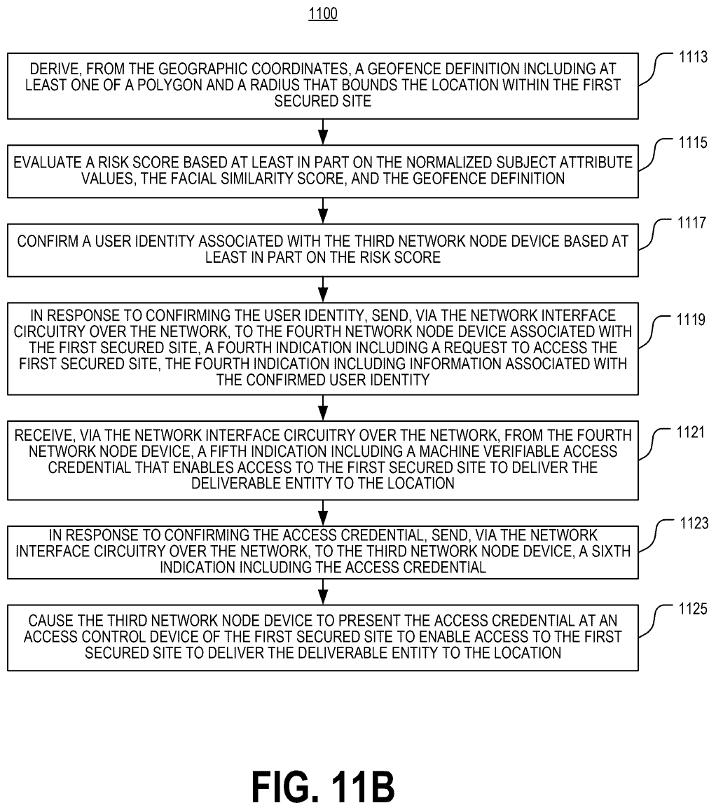

FIGS. 11A-11B illustrate one embodiment of a method 1100 performed by a network node device of access authorization of a secured site in accordance with various aspects as described herein. In FIG. 11A, the method 1100 can be performed by a first network node device including processing circuitry operatively coupled to memory and network interface circuitry operable to communicate over a network. Further, the first network node device is communicatively coupled, via the network interface circuitry over the network, to a second network node device associated with a service, a third network node device associated with a fulfillment-side user account of the service, and a fourth network node device associated with a first secured site of a plurality of secured sites. The method 1100 may start, for instance, at block 1101 where it can include receiving, via the network interface circuitry over the network, from the second network node device, a first indication including a request to access the first secured site to deliver a deliverable entity to a location within the first secured site identified by geographic coordinates. At block 1105, the method 1100 can include obtaining, from among a template repository storing a plurality of access credentialing dataset templates that correspond to the plurality of secured sites, an access credentialing dataset template corresponding to the first secured site to obtain an obtained template, each template including subject attribute user interface elements configured to capture information to complete an access credentialing dataset. At block 1107, the method 1100 can include sending, via the network interface circuitry over the network, to the third network node device, a second indication including the obtained template and instructions that cause the third network node device to present the subject attribute user interface elements to capture information to complete the access credentialing dataset corresponding to the first secured site. At block 1109, the method 1100 can include receiving, via the network interface circuitry over the network, from the third network node device, a third indication including a completed access credentialing dataset having a self-image captured by the third network node device and an identification document image. At block 1111, the method 1100 can include extracting, from the completed access credentialing dataset, machine readable subject attribute values by performing optical character recognition on at least one image of a government issued identification document, normalizing the extracted values to a canonical format to obtain normalized subject attribute values, and computing a facial similarity score between the self-image and the identification document image.

In FIG. 11B, the method 1100 can include deriving, from the geographic coordinates, a geofence definition including at least one of a polygon and a radius that bounds the location within the first secured site, as represented by block 1113. At block 1115, the method 1100 can include evaluating a risk score based at least in part on the normalized subject attribute values, the facial similarity score, and the geofence definition. At block 1117, the method 1100 can include confirming a user identity associated with the third network node device based at least in part on the risk score. At block 1119, the method 1100 can include, in response to confirming the user identity, sending, via the network interface circuitry over the network, to the fourth network node device associated with the first secured site, a fourth indication including a request to access the first secured site, the fourth indication including information associated with the confirmed user identity. At block 1121, the method 1100 can include receiving, via the network interface circuitry over the network, from the fourth network node device, a fifth indication including a machine verifiable access credential that enables access to the first secured site to deliver the deliverable entity to the location. At block 1123, the method 1100 can include, in response to confirming the access credential, sending, via the network interface circuitry over the network, to the third network node device, a sixth indication including the access credential. At block 1125, the method 1100 can include causing the third network node device to present the access credential at an access control device of the first secured site to enable access to the first secured site to deliver the deliverable entity to the location.

FIG. 12 illustrates another embodiment of a network node device 1200 in accordance with various aspects as described herein. In FIG. 12, device 1200 includes processing circuitry 1201 that is operatively coupled to input/output interface 1205, artificial intelligence circuitry 1209, network interface circuitry 1211, power source 1213, memory 1215 including random access memory (RAM) 1217, read-only memory (ROM) 1219, and storage medium 1221 or the like, communication subsystem 1231, or any other component, or any combination thereof.

The input/output interface 1205 may be configured to provide a communication interface to an input device, output device, or input and output device. The device 1200 may be configured to use an input/output device via input/output interface 1205 such as the location device (e.g., GPS module) and the display device (e.g., touchscreen). An output device may use the same type of interface port as an input device. For example, a USB port may be used to provide input to and output from the device 1200. The output device may be a speaker, a sound card, a video card, a display, a monitor, a printer, an actuator, an emitter, a smartcard, another output device, or any combination thereof. The device 1200 may be configured to use an input device via input/output interface 1205 to allow a user to capture information into the device 1200. The input device may include a touch-sensitive or presence-sensitive display, an optical sensor (e.g., a digital camera, a digital video camera, a web camera, etc.), a location device, a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical or image sensor, an infrared sensor, a proximity sensor, another like sensor, or any combination thereof.

In FIG. 12, storage medium 1221 may include operating system 1223, application program 1225, data 1227, the like, or any combination thereof. In other embodiments, storage medium 1221 may include other similar types of information. Certain devices may utilize all of the components shown in FIG. 12, or only a subset of the components. The level of integration between the components may vary from one device to another device. Further, certain devices may contain multiple instances of a component, such as multiple processors, memories, neural networks, network connection interfaces, transceivers, etc.

In FIG. 12, processing circuitry 1201 may be configured to process computer instructions and data. Processing circuitry 1201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1201 may include two central processing units (CPUs). Data may be information in a form suitable for use by a computer.

In FIG. 12, the AI circuitry 1209 may be configured to learn to perform tasks by considering examples. For instance, the AI circuitry 1209 can include one or more specialized AI processing subsystems or modules operable to execute models that support secured-site access workflows, including (i) optical character recognition (OCR) on identification-document images, (ii) facial-similarity scoring between a self-image and a document headshot, (iii) liveness detection to identify spoofing, and (iv) optional anomaly/risk models that aggregate device, account, geofence, and temporal signals. The AI circuitry 1209 may be implemented using GPUs, NPUs, TPUs, or other accelerators, or as virtualized AI containers on shared hardware, and cooperates with the processing circuitry 1201 and memory 1215 to perform extraction, normalization, similarity and liveness computations, and to provide scores and features used by the risk evaluation described herein.

The network interface circuitry 1211 may be configured to provide a communication interface to network 1243a. The network 1243a may encompass wired or wireless networks such as a local-area network (LAN), a wide-area network (WAN), a computer network, a wireless network, a telecommunications network, another like network or any combination thereof. For example, network 1243a may comprise a Wi-Fi network. The network interface circuitry 1211 may be configured to include a receiver and a transmitter interface used to communicate with one or more other devices over a communication network according to one or more communication protocols, such as Ethernet, TCP/IP, SONET, ATM, or the like. The network interface circuitry 1211 may implement receiver and transmitter functionality appropriate to the communication network links (e.g., optical, electrical, and the like). The transmitter and receiver functions may share circuitry components, software or firmware, or alternatively may be implemented separately.

The RAM 1217 may be configured to interface via a bus 1203 to the processing circuitry 1201 to provide storage or caching of data or computer instructions during the execution of software programs such as the operating system, application programs, and device drivers. The ROM 1219 may be configured to provide computer instructions or data to processing circuitry 1201. For example, the ROM 1219 may be configured to store invariant low-level system code or data for basic system functions such as basic input and output (I/O), startup, or reception of keystrokes from a keyboard that are stored in a non-volatile memory. The storage medium 1221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, the storage medium 1221 may be configured to include an operating system 1223, an application program 1225 such as web browser, web application, user interface, browser data manager as described herein, a widget or gadget engine, or another application, and a data file 1227. The storage medium 1221 may store, for use by the device 1200, any of a variety of various operating systems or combinations of operating systems.

The storage medium 1221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. The storage medium 1221 may allow the device 1200a-b to access computer-executable instructions, application programs or the like, stored on transitory or non-transitory memory media, to off-load data, or to upload data. An article of manufacture, such as one utilizing a communication system may be tangibly embodied in the storage medium 1221, which may comprise a device readable medium.

The processing circuitry 1201 may be configured to communicate with network 1243b using the communication subsystem 1231. The network 1243a and the network 1243b may be the same network or networks or different network or networks. The communication subsystem 1231 may be configured to include one or more transceivers used to communicate with the network 1243b. For example, the communication subsystem 1231 may be configured to include one or more transceivers used to communicate with one or more remote transceivers of another device capable of wireless communication according to one or more communication protocols, such as IEEE 802.11, CDMA, WCDMA, GSM, LTE, UTRAN, WiMax, or the like. Each transceiver may include transmitter 1233 or receiver 1235 to implement transmitter or receiver functionality, respectively, appropriate to the RAN links (e.g., frequency allocations and the like). Further, transmitter 1233 and receiver 1235 of each transceiver may share circuitry components, software, or firmware, or alternatively may be implemented separately.

In FIG. 12, the communication functions of the communication subsystem 1231 may include data communication, voice communication, multimedia communication, short-range communications such as Bluetooth, near-field communication, location-based communication such as the use of the global positioning system (GPS) to determine a location, another like communication function, or any combination thereof. For example, the communication subsystem 1231 may include cellular communication, Wi-Fi communication, Bluetooth communication, and GPS communication. The network 1243b may encompass wired or wireless networks such as a local-area network (LAN), a wide-area network (WAN), a computer network, a wireless network, a telecommunications network, another like network or any combination thereof. For example, the network 1243b may be a cellular network, a Wi-Fi network, or a near-field network. The power source 1213 may be configured to provide alternating current (AC) or direct current (DC) power to components of the device 1200a-b.

The features, benefits or functions described herein may be implemented in one of the components of the device 1200 or partitioned across multiple components of the device 1200. Further, the features, benefits, or functions described herein may be implemented in any combination of hardware, software, or firmware. In one example, communication subsystem 1231 may be configured to include any of the components described herein. Further, the processing circuitry 1201 may be configured to communicate with any of such components over the bus 1203. In another example, any of such components may be represented by program instructions stored in memory that when executed by the processing circuitry 1201 perform the corresponding functions described herein. In another example, the functionality of any of such components may be partitioned between the processing circuitry 1201 and the communication subsystem 1231. In another example, the non-computationally intensive functions of any of such components may be implemented in software or firmware and the computationally intensive functions may be implemented in hardware.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts for illustrative purposes, but the embodiments are similarly applicable in other contexts not explicitly described.

In one exemplary embodiment, a method is provided in which a first network node device coordinates a delivery to a secure site: it talks over a network to (i) a service's server, (ii) a device signed in with a fulfillment-side (courier) account of the service, and (iii) a server for one secure site among many. The first device receives a request to enter the secure site to deliver something to a spot identified only by map coordinates; pulls from a repository the site-specific credentialing template; sends that template to the courier device with instructions to display and collect the required fields; receives the completed dataset including a selfie and an image of a government ID; reads text from the ID image (OCR), converts the fields into standard formats, and computes a face-match score between the selfie and the ID image; builds a geofence around the delivery location; computes a risk score using the normalized fields, the face-match score, and the geofence; confirms the courier's identity based on that risk score; asks the site's server for access including identity information; receives a machine-verifiable access credential; sends that credential to the courier device; and causes the courier device to present the credential at the site's access-control device to enter and complete the delivery.

In another exemplary embodiment, the method further refines the “obtained template” by first determining which secure sites are near the courier device's current location, selecting the templates for the target site and those nearby sites from the repository, and combining their user-interface elements to form the final template used for data capture.

In another exemplary embodiment, the method further checks that the completed dataset matches a defined schema (correct formats and required fields) and, if any field fails, sends an error message back to the courier device identifying the specific validation issue.

In another exemplary embodiment, confirming the courier's identity also includes running liveness detection on the selfie to produce a liveness score and accepting identity only when both the face-match and liveness scores meet their thresholds.

In another exemplary embodiment, normalizing the extracted values includes converting dates to ISO-8601, phone numbers to E.164, coordinates to fixed-precision WGS-84, and formatting identification numbers with a jurisdiction prefix.

In another exemplary embodiment, deriving the geofence includes computing a circle of a policy-selected radius centered on the coordinates and inserting that geofence into the site-access request so the issued credential encodes the same geofence.

In another exemplary embodiment, computing the risk score aggregates features such as the courier account's history, time-of-day, the courier device's attestation state, and how far the coordinates are from the site perimeter.

In another exemplary embodiment, the method redacts the completed dataset to a minimum-information payload by tokenizing selected attributes with a cryptographic hash and includes only that minimum payload in the request sent to the site server.

In another exemplary embodiment, the method verifies the digital signature on the machine-verifiable credential using a trust anchor for the site and rejects the credential if signature verification fails.

In another exemplary embodiment, the method generates a device-bound version of the access credential by binding it to a hardware-backed public key of the courier device and packaging it as a QR code or NFC payload, and sends that device-bound version to the courier device.

In one exemplary embodiment, a first network node device includes memory, a network interface, and processing circuitry, and is connected over a network to (i) a service's server, (ii) a device signed in with a fulfillment-side account of the service, and (iii) a server for one secure site among many. Program instructions in memory make the device perform the operations summarized above: receive the delivery-access request; fetch and send the site's template to the courier device for completion; receive the completed dataset with selfie and ID image; run OCR, normalize fields, and compute a face-match score; derive a geofence; compute a risk score; confirm identity; request access from the site server; receive a machine-verifiable credential; send it to the courier device; and cause presentation of the credential at the site's access-control device to gain entry and deliver.

In another exemplary embodiment, that device additionally selects or constructs the template by finding nearby secure sites relative to the courier device, choosing the corresponding templates from the repository, and merging their user-interface elements to form the final template.

In another exemplary embodiment, that device pre-populates one or more template fields using data from the service's server and marks those fields read-only in the user interface.

In another exemplary embodiment, that device validates the completed dataset against a schema and, on any failure, sends an error message back to the courier device identifying the field-level issue.

In another exemplary embodiment, that device performs selfie liveness detection to generate a liveness score and accepts identity only when both the liveness and face-match scores meet thresholds.

In another exemplary embodiment, that device includes the geofence and a requested time window in the access request so that the issued credential carries both constraints.

In another exemplary embodiment, that device verifies the credential's digital signature using a site trust anchor and rejects the credential if verification fails.

In another exemplary embodiment, that device produces a device-bound credential by binding it to a hardware-backed public key of the courier device, encodes it as a QR or NFC payload, and includes that device-bound version in what it sends to the courier device.

In another exemplary embodiment, that device redacts the completed dataset to a minimum-information payload, includes the minimum payload in the access request, logs an audit trail correlating all messages with timestamps and identifiers, and later deletes selected attributes after a retention period.

In one exemplary embodiment, a system includes the first network node device and a template repository storing credentialing templates for multiple secure sites; the device connects to the service's server, the courier device, and the secure-site server and then performs the same operations outlined above-handling the request, fetching and sending the template, ingesting and processing the completed dataset (OCR, normalization, face-match), building a geofence and risk score, confirming identity, requesting access, receiving a machine-verifiable credential, sending it to the courier device, and causing presentation of the credential at the site's access-control device to enter and deliver.

The previous detailed description is merely illustrative in nature and is not intended to limit the present disclosure, or the application and uses of the present disclosure. Furthermore, there is no intention to be bound by any expressed or implied theory presented in the preceding field of use, background, summary, or detailed description. The present disclosure provides various examples, embodiments and the like, which may be described herein in terms of functional or logical block elements. The various aspects described herein are presented as methods, devices (or apparatus), systems, or articles of manufacture that may include a number of components, elements, members, modules, nodes, peripherals, or the like. Further, these methods, devices, systems, or articles of manufacture may include or not include additional components, elements, members, modules, nodes, peripherals, or the like.

Furthermore, the various aspects described herein may be implemented using standard programming or engineering techniques to produce software, firmware, hardware (e.g., circuits), or any combination thereof to control a computing device to implement the disclosed subject matter. It will be appreciated that some embodiments may be comprised of one or more generic or specialized processors such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the methods, devices and systems described herein. Alternatively, some or all functions could be implemented by a state machine that has no stored program instructions, or in one or more application specific integrated circuits (ASICs), in which each function or some combinations of certain of the functions are implemented as custom logic circuits. Of course, a combination of the two approaches may be used. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The term “article of manufacture” as used herein is intended to encompass a computer program accessible from any computing device, carrier, or media. For example, a computer-readable medium may include: a magnetic storage device such as a hard disk, a floppy disk or a magnetic strip; an optical disk such as a compact disk (CD) or digital versatile disk (DVD); a smart card; and a flash memory device such as a card, stick or key drive. Additionally, it should be appreciated that a carrier wave may be employed to carry computer-readable electronic data including those used in transmitting and receiving electronic data such as electronic mail (e-mail) or in accessing a computer network such as the Internet or a local area network (LAN). Of course, a person of ordinary skill in the art will recognize many modifications may be made to this configuration without departing from the scope or spirit of the subject matter of this disclosure.

Throughout the specification and the embodiments, the following terms take at least the meanings explicitly associated herein, unless the context clearly dictates otherwise. Relational terms such as “first” and “second,” and the like may be used solely to distinguish one entity or action from another entity or action without necessarily requiring or implying any actual such relationship or order between such entities or actions. The term “or” is intended to mean an inclusive “or” unless specified otherwise or clear from the context to be directed to an exclusive form. Further, the terms “a,” “an,” and “the” are intended to mean one or more unless specified otherwise or clear from the context to be directed to a singular form. The term “include” and its various forms are intended to mean including but not limited to. References to “one embodiment,” “an embodiment,” “example embodiment,” “various embodiments,” and other like terms indicate that the embodiments of the disclosed technology so described may include a particular function, feature, structure, or characteristic, but not every embodiment necessarily includes the particular function, feature, structure, or characteristic. Further, repeated use of the phrase “in one embodiment” does not necessarily refer to the same embodiment, although it may. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. A device or structure that is “configured” in a certain way is configured in at least that way, but may also be configured in ways that are not listed.

What is claimed is:

1. A method, comprising:
performing by a first network node device including processing circuitry operatively coupled to memory and network interface circuitry operable to communicate over a network, the first network node device being communicatively coupled, via the network interface circuitry over the network, to a second network node device associated with a service, a third network node device associated with a fulfillment-side user account of the service, and a fourth network node device associated with a first secured site of a plurality of secured sites,
receiving, via the network interface circuitry over the network, from the second network node device, a first indication including a request to access the first secured site to deliver a deliverable entity to a location within the first secured site identified by geographic coordinates;
obtaining, from among a template repository storing a plurality of access credentialing dataset templates that correspond to the plurality of secured sites, an access credentialing dataset template corresponding to the first secured site to obtain an obtained template, each template including subject attribute user interface elements configured to capture information to complete an access credentialing dataset;
sending, via the network interface circuitry over the network, to the third network node device, a second indication including the obtained template and instructions that cause the third network node device to present the subject attribute user interface elements to capture information to complete the access credentialing dataset corresponding to the first secured site;
receiving, via the network interface circuitry over the network, from the third network node device, a third indication including a completed access credentialing dataset having a self-image captured by the third network node device and an identification document image;
extracting, from the completed access credentialing dataset, machine readable subject attribute values by performing optical character recognition on at least one image of a government issued identification document, normalizing the extracted values to a canonical format to obtain normalized subject attribute values, and computing a facial similarity score between the self-image and the identification document image;
deriving, from the geographic coordinates, a geofence definition including at least one of a polygon and a radius that bounds the location within the first secured site;
evaluating a risk score based at least in part on the normalized subject attribute values, the facial similarity score, and the geofence definition;
confirming a user identity associated with the third network node device based at least in part on the risk score;
in response to confirming the user identity, sending, via the network interface circuitry over the network, to the fourth network node device associated with the first secured site, a fourth indication including a request to access the first secured site, the fourth indication including information associated with the confirmed user identity;
receiving, via the network interface circuitry over the network, from the fourth network node device, a fifth indication including a machine verifiable access credential that enables access to the first secured site to deliver the deliverable entity to the location;
sending, via the network interface circuitry over the network, to the third network node device, a sixth indication including the access credential; and
causing the third network node device to present the access credential at an access control device of the first secured site to obtain access to the first secured site to deliver the deliverable entity to the location.

2. The method of claim 1, wherein the step of obtaining the obtained template comprises:
determining those of the plurality of secured sites that are geographically proximate to a current location of the third network node device to obtain a set of proximate secured sites;
selecting, from among the plurality of access credentialing dataset templates that correspond to the plurality of secured sites, access credentialing dataset templates corresponding to the first secured site and to the set of proximate secured sites to obtain a set of selected templates; and
combining subject attribute user interface elements from the set of selected templates to form the obtained template.

3. The method of claim 1, further comprising:
validating that the completed access credentialing dataset conforms to a schema specifying canonical formats and required fields; and
responsive to detecting a non-conformance, sending, via the network interface circuitry over the network, to the third network node device, a seventh indication including an error message identifying a validation failure.

4. The method of claim 1, wherein the step of confirming the user identity further comprises:
performing liveness detection on the self-image to obtain a liveness score; and
accepting the user identity when both the facial similarity score and the liveness score satisfy respective thresholds.

5. The method of claim 1, wherein the step of normalizing the extracted values to canonical formats includes at least one of converting dates to ISO-8601 format, converting telephone numbers to E.164 format, representing the geographic coordinates in WGS-84 format with fixed precision, or formatting an identification number as a jurisdiction prefixed identifier.

6. The method of claim 1, wherein the step of deriving the geofence definition includes computing a circular geofence having a radius selected from a site policy repository and centered at the geographic coordinates, and including the geofence definition in the fourth indication such that the machine verifiable access credential encodes the geofence definition.

7. The method of claim 1, wherein the step of evaluating the risk score includes aggregating features including at least one of a history associated with the user account, a time-of-day factor, a device attestation state of the third network node device, or a distance of the geographic coordinates from a perimeter of the first secured site.

8. The method of claim 1, further comprising:
redacting the completed access credentialing dataset to produce a minimum information payload by tokenizing at least one subject attribute value using a cryptographic hash; and
wherein the step of sending the fourth indication includes the minimum information payload.

9. The method of claim 1, further comprising:
verifying a digital signature of the machine verifiable access credential using a trust anchor associated with the first secured site; and
rejecting the machine verifiable access credential responsive to a failed verification.

10. The method of claim 1, further comprising:
generating a device bound version of the machine verifiable access credential by binding the machine verifiable access credential to a hardware backed public key of the third network node device and encoding the device bound version as at least one of a quick response (QR) code and a near field communication (NFC) payload, wherein the sixth indication includes the device bound version.

11. A first network node device, comprising:
a memory;
a network interface circuitry operable to communicate over a network;
a processing circuitry operatively coupled to the memory and the network interface circuitry, the first network node device being communicatively coupled, via the network interface circuitry over the network, to a second network node device associated with a service, a third network node device associated with a fulfillment-side user account of the service, and a fourth network node device associated with a first secured site of a plurality of secured sites; and
wherein the memory includes instructions executable by the processing circuitry, whereby the processing circuitry is configured to:
receive, via the network interface circuitry over the network, from the second network node device, a first indication including a request to access the first secured site to deliver a deliverable entity to a location within the first secured site identified by geographic coordinates;
obtain, from among a template repository storing a plurality of access credentialing dataset templates that correspond to the plurality of secured sites, an access credentialing dataset template corresponding to the first secured site to obtain an obtained template, each template including subject attribute user interface elements configured to capture information to complete an access credentialing dataset;
send, via the network interface circuitry over the network, to the third network node device, a second indication including the obtained template and instructions that cause the third network node device to present the subject attribute user interface elements to capture information to complete the access credentialing dataset corresponding to the first secured site;
receive, via the network interface circuitry over the network, from the third network node device, a third indication including a completed access credentialing dataset having a self-image captured by the third network node device and an identification document image;
extract, from the completed access credentialing dataset, machine readable subject attribute values by performing optical character recognition on at least one image of a government issued identification document, normalizing the extracted values to a canonical format to obtain normalized subject attribute values, and computing a facial similarity score between the self-image and the identification document image;
derive, from the geographic coordinates, a geofence definition including at least one of a polygon and a radius that bounds the location within the first secured site;
evaluate a risk score based at least in part on the normalized subject attribute values, the facial similarity score, and the geofence definition;
confirm a user identity associated with the third network node device based at least in part on the risk score;
in response to confirming the user identity, send, via the network interface circuitry over the network, to the fourth network node device associated with the first secured site, a fourth indication including a request to access the first secured site, the fourth indication including information associated with the confirmed user identity;
receive, via the network interface circuitry over the network, from the fourth network node device, a fifth indication including a machine verifiable access credential that enables access to the first secured site to deliver the deliverable entity to the location;
send, via the network interface circuitry over the network, to the third network node device, a sixth indication including the access credential; and
cause the third network node device to present the access credential at an access control device of the first secured site to obtain access to the first secured site to deliver the deliverable entity to the location.

12. The first network node device of claim 11, wherein the memory further stores instructions that, when executed by the processing circuitry, cause the processing circuitry to:
determine those of the plurality of secured sites that are geographically proximate to a current location of the third network node device to obtain a set of proximate secured sites;
select, from among the template repository storing the plurality of access credentialing dataset templates that correspond to the plurality of secured sites, access credentialing dataset templates corresponding to the first secured site and to the set of proximate secured sites to obtain a set of selected templates; and
combine subject attribute user interface elements from the set of selected templates to form the obtained template.

13. The first network node device of claim 11, wherein the memory further stores instructions that, when executed by the processing circuitry, cause the processing circuitry to:
pre-populate at least one subject attribute field of the obtained template using data received from the second network node device; and
mark the pre-populated field as read only in the subject attribute user interface elements.

14. The first network node device of claim 11, wherein the memory further stores instructions that, when executed by the processing circuitry, cause the processing circuitry to:
validate that the completed access credentialing dataset conforms to a schema specifying canonical formats and required fields; and
responsive to detecting a non-conformance, send, via the network interface circuitry over the network, to the third network node device, a seventh indication including an error message identifying a validation failure.

15. The first network node device of claim 11, wherein the memory further stores instructions that, when executed by the processing circuitry, cause the processing circuitry to:
perform liveness detection on the self-image to obtain a liveness score to obtain a liveness score; and
accept the user identity when both the facial similarity score and the liveness score satisfy respective thresholds.

16. The first network node device of claim 11, wherein the memory further stores instructions that, when executed by the processing circuitry, cause the processing circuitry to:
include the geofence definition and a requested access time window in the fourth indication such that a machine verifiable access credential issued in response encodes the geofence definition and the requested access time window.

17. The first network node device of claim 11, wherein the memory further stores instructions that, when executed by the processing circuitry, cause the processing circuitry to:
verify a digital signature of the machine verifiable access credential using a trust anchor associated with the first secured site and to reject the machine verifiable access credential responsive to a failed verification.

18. The first network node device of claim 11, wherein the memory further stores instructions that, when executed by the processing circuitry, cause the processing circuitry to:
generate a device bound version of the machine verifiable access credential by binding the machine verifiable access credential to a hardware-backed public key of the third network node device; and
encode the device bound version as a quick response (QR) code or a near field communication (NFC) payload, and to include the device bound version in the sixth indication.

19. The first network node device of claim 11, wherein the memory further stores instructions that, when executed by the processing circuitry, cause the processing circuitry to:
redact the completed access credentialing dataset to produce a minimum information payload by tokenizing at least one subject attribute value using a cryptographic hash;
include the minimum information payload in the fourth indication;
log an audit record correlating the first through sixth indications with timestamps and identifiers; and
initiate deletion of at least a subset of subject attribute values after a retention period elapses.

20. A system, comprising:
a first network node device including processing circuitry operatively coupled to memory and network interface circuitry operable to communicate over a network;
a template repository storing a plurality of access credentialing dataset templates that correspond to a plurality of secured sites;
wherein the first network node device is communicatively coupled, via the network interface circuitry over the network, to a second network node device associated with a service, a third network node device associated with a fulfillment-side user account of the service, and a fourth network node device associated with a first secured site of the plurality of secured sites; and
wherein the memory stores instructions that, when executed by the processing circuitry, cause the first network node device to perform operations comprising:
receive, from the second network node device, a first indication including a request to access the first secured site to deliver a deliverable entity to a location within the first secured site identified by geographic coordinates (the geographic coordinates);
obtain, from the template repository, an access credentialing dataset template corresponding to the first secured site to obtain an obtained template, each template including subject attribute user interface elements configured to capture information to complete an access credentialing dataset;
send, to the third network node device, a second indication including the obtained template and instructions that cause the third network node device to present the subject attribute user interface elements to capture information to complete the access credentialing dataset corresponding to the first secured site;
receive, from the third network node device, a third indication including a completed access credentialing dataset having a self-image captured by the third network node device and an identification document image;
extract, from the completed access credentialing dataset, machine readable subject attribute values by performing optical character recognition on at least one image of a government issued identification document, normalizing the extracted values to canonical formats to obtain normalized subject attribute values, and computing a facial similarity score between the self-image and the identification document image;
derive, from the geographic coordinates, a geofence definition comprising at least one of a polygon and a radius that bounds the location within the first secured site;
evaluate a risk score based at least in part on the normalized subject attribute values, the facial similarity score, and the geofence definition;
confirm a user identity associated with the third network node device based at least in part on the risk score;
in response to confirming the user identity, send, to the fourth network node device associated with the first secured site, a fourth indication including a request to access the first secured site, the fourth indication including information associated with the confirmed user identity;
receive, from the fourth network node device, a fifth indication including a machine verifiable access credential that enables access to the first secured site to deliver the deliverable entity to the location;
send, via the network interface circuitry over the network, to the third network node device, a sixth indication including the access credential; and
cause the third network node device to present the access credential at an access control device of the first secured site to obtain access to the first secured site to deliver the deliverable entity to the location.
